(19) United States
(12) Patent Application Publication
(10) Pub. No.: US 2004/0207131 A1
(43) Pub. Date: Oct. 21, 2004

(54) Apparatus and process for pressure assisted molding of hollow articles

(76) Inventor: Ronald Thomas, Chesterfield Twp., MI (US)

Correspondence Address: DINNIN & DUNN, P.C., 2701 CAMBRIDGE COURT, STE. 500, AUBURN HILLS, MI, 48326, US

(21) Appl. No.: 10/806,552

(22) Filed: Mar. 23, 2004

Related U.S. Application Data
(63) Continuation-in-part of application No. 10/085,372, filed on Feb. 28, 2002, now Pat. No. 6,716,387.
(60) Provisional application No. 60/272,156, filed on Feb. 28, 2001.

(51) Int. Cl. B29C 45/20

(52) U.S. Cl. 264/572; 264/328.16; 425/130

(57) ABSTRACT

The present invention provides a process for fluid assisted injection molding comprising the step of providing an injection molding apparatus having a mold body that defines a mold cavity. The process further comprises the steps of supplying a quantity of fluent plastic to the mold cavity, following by injecting a fluid into the mold cavity. A reservoir is selectively connectable to a plastic injection runner, and can be opened to the runner to receive molten plastic ejected by the introduction of the fluid to the mold cavity. When the reservoir is thusly connected, the pressure of the fluid forces the plastic through a supply passage, in a direction substantially opposite to its initial injection direction.

This application claims priority of U.S. Provisional Application No. 60/272,156, Filed: Feb. 28, 2001 and U.S. patent application Ser. No. 10/085,372, Filed: Feb. 28, 2002

### TECHNICAL FIELD

The present invention relates generally to fluid assisted injection molding processes, and more particularly to such a process utilizing an overfill reservoir selectively connectable to a fluent plastic supply line.

### BACKGROUND OF THE INVENTION

There are a wide variety of gas or fluid assisted injection molding apparatuses and processes available in the art. Injection molding generally comprises injecting a molten plastic under pressure (usually by a screw feed injector) into a closed two piece cavity. When the part cools, the mold pieces are separated and the part removed. There are various references to specific pressure profiles to best implement the molding process, and a plethora of plastic injection molding machines commercially available.

Gas or fluid assisted injection molding generally involves injecting gas into the fluid plastic material either during or after plastic injection to create a hollow within the part, see e.g. U.S. Pat. No. 4,101,617. This reduces the weight of the part and the cost of material used and then injecting fluid to create a hollow portion. Using less plastic than required to fill the mold cavity is called a “short shot”. More importantly, pressurizing the interior of the part forces the fluid plastic against the mold surface as it cools. When plastic cools, it shrinks, and tends to pull away from the mold surface, leaving unsightly sink marks. The cooling of the plastic within the mold also reduces the pressure of the plastic within the mold. There are a variety of gas or fluid assist controllers and equipment commercially available to maintain various desirable pressure profiles through the plastic injection and cooling cycles. See e.g., the commonly assigned U.S. Pat. No. No. 6,375,892.

In addition to pressure variation, timing and duration known process variables include the temperature of gas injection (see e.g., U.S. Pat. No. 5,728,325), the location of gas injection, and the medium injected (see e.g., U.S. Pat. No. 6,579,489). Fine tuning these variables with respect to specific plastics and with respect to specific sizes and shapes of parts has enabled molders to improve cycle time while improving the uniformity (and accuracy compared to specifications) of wall thickness while minimizing surface blemishes from flow lines or hesitation marks caused by the changing viscosity of the cooling plastic as it is injected into the mold.

Another variation of the injection process is known generally as overflow, overspill, spillovers or other similar names. This process generally involves injecting more plastic material into the mold cavity than the cavity will hold, and allowing material to flow into reservoirs at the remote ends of the plastic flow path to receive the excess. If the reservoir locations are chosen properly, the plastic must fill every bit of the mold cavity before the reservoirs are filled, thus ensuring complete mold fill out. Again, molding equipment utilizing the overflow concept is commercially available.

Combinations of overflow and fluid injection have generally been available for many years, see e.g., French Patent No. 1,145,441 (1957) and U.S. Pat. No. 4,140,672 (FIG. 15) for the purpose of generally speeding up the fill out process or to intentionally dispel fluid plastic from the part interior to create a hollow part. These processes have generally proven unreliable (poor repeatability). The typical combination process injects gas at or near the plastic inlet (sprue), pushing the plastic toward the overspill at the far end(s) of the mold cavity. This results in a flow of the cooling resin toward a small gate located at the opposite end of the cavity. When the resin cools, it is much less viscous and tends to resist flowing through the overspill gate. The plastic's resistance to shear also increases with the decrease in temperature, adding further resistance to travel through the overspill gate, and causing the resin flow to stall at the overspill entrance. This “blockage” or area of greater resistance to flow, can lead to or cause a number of problems or undesirable conditions. For example, this situation often prompts operators to utilize unnecessarily high gas injection pressures to move the resin through the overspill gate. Further, this undesired resistance may localize high gloss areas over the channel.

Typically, when confronted by the resistance of the cooling resin at the overspill gate, the gas will in effect migrate to “thin wall” sections of the plastic part causing quality/function problems. This is like blowing up a balloon with thin sports, the thicker areas will not stretch, causing the thin section to overstretch. As a result, parts are characterized by an increase in the resin wall thickness as the gas moves from the hotter gate area at the point of gas injection (more pliable resin is moved along by the gas) to the relatively cooler area at the end of the gas channel/entrance of the overspill (less pliable resin stays in place and is less affected by the gas). This results in non-uniform wall thickness. Further, if the amount of plastic flowing into the overspill is reduced, the amount of space the gas will occupy at a given pressure is similarly reduced, thus yielding a part heavier than desired. Further still, the use of gas injection at/near the point of plastic injection creates a need to have greater or even excessive gas injection delay times to insure that the hotter resin around the gage/pin is cooled sufficiently that the molten resin will not be blown off the gas pin. Similarly, longer gas injection delay times would also be necessary to ensure that the hotter resin around the gate/pin is cooled sufficiently so that the molten resin will not “foam up” (become mixed with resin). The higher the gas pressure to be used, the longer the injection delay required to avoid these problems.

The process parameters for various molded parts can vary greatly depending upon inter alia, the size of the part molded, the length of plastic travel, the type of plastic and the ambient conditions. In order to control the fill out, there have been attempts to utilize multiple points of plastic injection fed by heated runners leading from the plastic injection nozzle. Further, as discussed above, varying gas injection rates and locations have been attempted to urge the fluent plastic to rapidly cover the mold surface without leaving flow marks or having the gas blow out through the plastic, which would result in a gas pocket in an extremity of the mold resisting the fill out of the mold in that section. Further still, there is a critical balance to be struck between quantity and speed, as cycle time is critical in most manufacturing operations. Therefore, it is critical to cause the plastic to fill out the cavity completely as quickly as possible while providing a quality surface and utilizing as little plastic as possible and cooling the part as quickly as possible.

Another process variable which has been utilized has been to vary the size of the overflow reservoir, to limit the amount of plastic which may flow out of the cavity. This volume of the reservoir can be varied before the injection process to control the amount of plastic allowed to flow into the reservoir. This type of variable reservoir has typically been utilized at the downstream end of the mold cavity, where the plastic has traveled the grater length and tends to be the coolest and most viscous, which limits the effectiveness and sensitivity of the variable reservoir.

Another process concern arises in the use of a foamed plastic which includes air pockets or bubbles within the plastic to create a lighter part. The various molding techniques described above have been utilized with various levels of success with respect to foamed plastic. However, creating an internal air pocket with injected molding can compress the foamed plastic and increase material density. An important factor in utilizing foamed plastic is to control the flow of the plastic and entrapped air as it enters the cavity and experiences the initial pressure drop.

Other patents that generally relate to the disclosed invention and which disclose the state of the art include:

U.S. Pat. No. 5,090,886 to Jaroschek discloses the use of multiple side cavities selectively connected to the mold cavity via reciprocal stuffer pistons.

U.S. Pat. No. 5,098,637 discloses a gas assist process utilizing “spill cavities”, and the use of multiple gas injections and spill cavities.

U.S. Pat. No. 6,354,826, which discloses the use of gas injection pins which allow for the injection of fluid at one or more locations in the mold cavity.

U.S. Pat. No. 6,372,177, which discloses the use of one or more spill chambers with inlets that are enlarged after the plastic injection and during the gas injection.

### SUMMARY OF THE INVENTION

In one aspect, an injection molding apparatus is provided. The injection molding apparatus includes a cavity for forming a hollow plastic part, a source of fluent plastic fluidly connectable to the cavity, and a runner for supplying fluent plastic from the source to the cavity. At least one fluid injection pin is provided and is mounted to the mold body and connectable to a fluid source. A reservoir is also provided and is positioned remote from the cavity, the reservoir is selectively connectable to the runner via a sub-runner. Finally, a valve is positioned adjacent a mouth of the sub-runner. The valve is operable between a first state at which the reservoir is fluidly connected to the runner and a second state at which the reservoir is blocked from fluid communication with the runner. The reservoir has a pneumatically variable capacity.

In another aspect, a process for injection molding of fluid filled plastic bodies is provided. The process includes the steps of providing an injection molding apparatus having a mold body that defines a mold cavity, and a source of flowable plastic material fluidly connectable to the mold cavity with a supply passage. At least one reservoir is also provided and is fluidly connectable to the supply passage with a control valve. At least one fluid injection pin is also provided and is connectable to a fluid source. The process includes the steps of injecting a quantity of flowable plastic into an interior of the mold cavity through the supply passage, and cooling part of the injected plastic along the walls of the mold cavity, providing an interior of flowable plastic melt. The process may also include the step of selectively expelling at least a potion of the interior of flowable plastic melt into the supply passage, and selectively expelling at least a portion of fluent plastic from the supply passage into the reservoir.

In yet another aspect, a method of forming a hollow injection molded plastic part is provided. The method includes the steps of providing a mold body having a mold cavity, connecting a source of fluent plastic to the mold cavity with a runner passage, and mounting at least one fluid injection pin to the mold body, and connecting the pin to a fluid source. The method further includes the steps of injecting a quantity of fluent plastic via the runner into the mold cavity, and injecting a quantity of fluid into the mold cavity, thereby expelling a portion of the quantity of fluent plastic to the runner, leaving a hollow plastic body around the periphery of the mold cavity. The method finally includes the step of selectively connecting the runner to a reservoir and expelling a quantity of fluent plastic to the reservoir, and varying the capacity of the reservoir before or during the expelling of the plastic into the reservoir.

### BRIEF DESCRIPTION OF THE DRAWINGS

FIG. 1 is a system level diagram of a pressure assisted injection molding apparatus according to the present invention.

FIG. 2 is a partial sectioned side view of an apparatus similar to FIG. 1.

### DETAILED DESCRIPTION

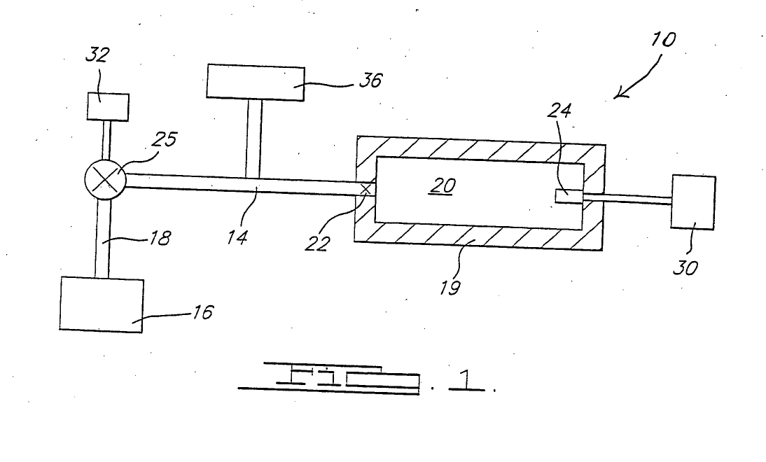

Referring to FIG. 1, there is shown a system level diagram of an injection molding apparatus 10 for undertaking a pressure assisted injection molding process according to the present invention. Apparatus 10 preferably includes a mold body 19, a fluent plastic source 36, a reservoir 16, and a fluid source 30. Fluent plastic source 36 is preferably connected via a runner 14 to mold cavity 20 for supplying fluent plastic thereto. It should be appreciated that the plastic injection nozzle may communicate directly to the mold cavity in variations of the processes described herein. A gate 22 having a restricted diameter preferably connects runner 14 to cavity 20. Suitable injection nozzles are commercially available from IMS, and mold cavities are typically custom made and available from a plurality of tool and die shops. A fluid injection pin 24, which is fluidly connected to a fluid source 30, extends into mold cavity 20, and can deliver fluid into an interior of cavity 20 when desired. Although a single pin is illustrated, it should be appreciated that multiple pins, connected the same or different fluid sources, can be utilized at a variety of locations throughout the mold. Runner 14 preferably fluidly connect mold cavity 20 to reservoir 16, which is positioned remotely from mold cavity 20, via a sub-runner 18. Fluid communication between reservoir 16 and runner 14 (and thus mold cavity 20) is initiated and terminated with a control valve 25. In the preferred embodiment, control valve 25 is hydraulically actuated with fluid from a hydraulic fluid source 32, however, it should be appreciated that control valve 25 could be actuated by pneumatic, electromagnetic, or some other means.

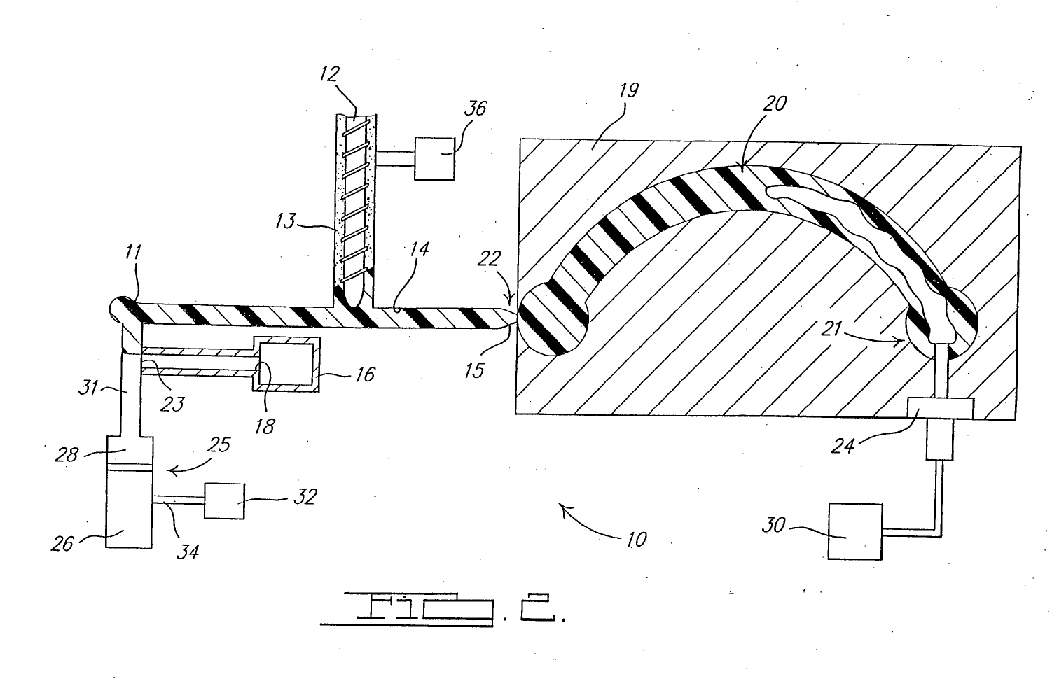

Referring to FIG. 2, there is shown a partial sectioned side view of an apparatus 10 according to the embodiment diagrammed in FIG. 1. Apparatus 10 preferably includes a conventional threaded-shaft sprue 12 positioned in a delivery shaft 13 for delivering molten plastic to the mold. It should be appreciated, however, that a different style of extruder, piston, or some other system for delivering molten plastic might be used. Shaft 13 is connected to runner 14, which is preferably a substantially cylindrical passage having a tapered injection end 15 and an ejection end 17. Injection end 15 is positioned adjacent gate 22 in mold body 19. Mold body 19 is preferably metallic and has two separable halves (only one is illustrated), which when closed define mold cavity 20. Mold cavity 20 is illustrated in FIG. 2 as generally tube shaped, however, it should be appreciated that mold cavity 20 might have any of a great number of different shapes, depending on the desired shape of the part to be molded therein. Fluid injection pin 24 is preferably positioned at a downstream end 21 of mold cavity 20, and extends partially into an interior of cavity 20.

Runner 14 is preferably fluidly connectable to sub-runner 18 at its ejection end 17. In the preferred embodiment, control valve 25 includes a hydraulically controlled piston 28. Piston 28 preferably has a control surface 29 exposed to fluid pressure in a hydraulic cylinder 26, and a substantially cylindrical end portion 31. Piston 28 has an extended position at which end portion 31 blocks an open end 23 of sub-runner 18, blocking fluid communication between sub-runner 18 and runner 14, thereby blocking fluid communication between cavity 20 and reservoir 16. Piston 28 also has a retracted position at which end portion 31 does not block open end 23 and therefore allows fluid communication between sub-runner 18 and runner 14, and can be moved between its two respective positions by controlling the hydraulic pressure supplied to chamber 26. If desired, a biasing spring (not shown) may be positioned in chamber 26 to bias piston 28 toward its extended position. Action of the piston 28 may be remotely controlled via a preprogrammed controller such as with a Direct Logic 205 CPU signaling a Proportionair BBZ servo control valve to provide a pneumatic control signal. The piston may also be selectively activated to partially open end 23 to control the flow into reservoir 16.

When initiation of a typical pressure assisted injection molding cycle is desired, the separable halves of mold body 19 are closed and secured. Fluent plastic source 36 is preferably a conventional heated plastic supply, and delivers fluent plastic to sprue 12 in a conventional manner. In the embodiment shown in FIG. 2, sprue 12 is rotated to drive molten plastic through delivery shaft 13 and into runner 14. At cycle initiation, hydraulic piston 28 should be held at its extended position, blocking fluid communication between runner 14 and reservoir 16. The rotation of sprue 12 delivers molten plastic to runner 14 and substantially fills runner 14 relative quickly, at which point the molten plastic begins to pass through gate 22, filling cavity 20. During the injection process, the heat and pressure of the plastic that follows through sprue 12 keeps the plastic in the runner fluid during the injection process. Further, the runner 14 itself becomes heated by the continuous flow of molten plastic and helps maintain the temperature of the molten plastic during subsequent cycles. As the plastic clears the gate, it rapidly loses pressure as it enters the mold cavity, and begins to cool. It is thus critical to quickly fill the mold cavity to ensure a smooth and even coverage of the mold surface. Plastic delivery preferably continues until mold cavity 20 is packed to the greatest pressure possible by the present plastic injection process. In other embodiments, as described below, however, plastic injection can be terminated prior to filling the cavity entirely.

Once cavity 20 has been packed to the desired condition, injection of a fluid under pressure through pin 24 can begin. In the preferred embodiment, a brief delay is allowed between the termination of plastic injection and the initiation of fluid injection, allowing the plastic to begin to solidify along the exterior mold surfaces, however, fluid injection may be initiated immediately after cessation of plastic injection if desired, or might even be initiated before plastic injection ends. There are myriad available pins for fluid injection, including Applicant's ANP-series gas pin. The initial injection pressure depends upon the size of the part, the mold, and the size of the desired hollow space. Since the initial pressure will occur at appoint of substantial fill out, the hollow created by the fluid injection will be the result of: (1) the shrinkage of plastic; and (2) the more complete fill out or packing of plastic into the mold caused by the increased pressure. The fluid most commonly used for the initial pressurization is compressed air, however, it is contemplated that other fluids, for example compressed nitrogen gas or water, may be preferred for particular molding applications. The fluid may be heated, chilled, or injected at ambient temperatures. The injected fluid creates an expanding pocket or hollow in the mold, and the consequent rising pressure of the fluid drives plastic to the furthest recesses of the mold, forcing the plastic relatively tightly against the interior mold surfaces. In order to ensure an even part thickness and to maximize the quality of the surface finish, it is preferred to maintain the pressure within the part for 2 to 10 second after injection. It should be appreciated, however, that the pressure might be lowered or raised during this dwell portion of the cycle. Further, additional fluid may be injected to maintain cavity pressure lost due to plastic cooling and shrinkage.

During the filling of cavity 20, the injected plastic begins to cool, resulting in partial hardening of the plastic adjacent the internal mold surfaces, yet leaving a flowable, molten plastic melt portion in the center of the molded article. In addition to cooling and hardening of the plastic at the exterior of the molded article, the melt portion in the center of the mold undergoes a degree of cooling. In the embodiment shown in FIG. 2, once mold cavity 20 is substantially filled, the plastic which has remained in the mold longest, and thus undergone the greatest degree of cooling is the plastic filling the mold cavity closest to its downstream end 21. Consequently, the downstream volume of the interior melt portion is slightly cooler and more viscous than the volume closer to gate 22.

Because valve 25 preferably remains closed during plastic and fluid injection, the pressure in the molding apparatus can build considerably during injection of fluid. When the desired dwell time has elapsed, valve 25 is hydraulically actuated, opening fluid communication between runner 14 and sub-runner 18. Because mold cavity 20 is under pressure from the injected fluid, the opening of valve 25 causes the molten plastic in runner 14 to begin to flow through sub-runner 18 toward reservoir 16. As plastic flows through runner 14, molten plastic (the interior melt) begins the flow from cavity 20 through gate 22, and thenceforth to runner 14. In the preferred embodiment, the volume of runner 14 is approximately equal to or greater than the volume of molten plastic expelled from cavity 20. There are at least two advantages in bleeding off the fluid plastic by opening the run off reservoir after pressure has been built up in the mold cavity. First, the movement of fluid plastic material is initiated after a cavity is established within the part. This results in a more even wall thickness of the molded part. Further, this results in a more laminar flow of the fluid plastic core, which results in more uniform part production. The distinction is somewhat like comparing the unpressurized bleeding of fluid lines to purging the lines with a burst of air. Although the interior surface quality of the molded part is not critical, the purpose is to leave as uniform a deposit of plastic as possible upon the mold surface. The second advantage is that the dwell time allows the part surface to set up before the remaining fluid plastic is bled out, and thus the part surface is more resistant to the shear forces resulting from the flow of the fluid plastic toward the runner.

It is also contemplated that the various processes described herein can utilize a variety of reservoirs to receive plastic expelled from the mold cavity, each preferably selectively connected to the mold cavity, for example through the use of a pneumatically or electrically operated piston. Thus, depending on the shape of the part, these reservoirs can be selectively opened during the molding process to facilitate plastic flow to the specific region of the selected reservoirs. the timing of the opening and closing of the various reservoirs can be pre-selected to first facilitate flow to mold extremities or to restricted areas where flow is most important. The timing parameters can be adjusted, if desired, after initial set up to fine tune the process for a given part in given ambient conditions.

Once the desired quantity of plastic has been evacuated to reservoir 16, valve 25 is closed, allowing runner 14 to become packed with any additional plastic ejected from the mold. It is preferable to locate the fluid injection pin or pins at a point or points in the mold most downstream of the gate, while still allowing for a desired part thickness, as the drawing Figures illustrate, although it should be appreciated that the pin might be positioned elsewhere. Because the preferred arrangement ejects the interior melt from mold cavity 20 in an upstream direction, i.e., toward the plastic supply, the lesser cooled portion of the melt positioned closest to gate 22 is ejected first, with the more downstream portion of the melt ejected later. Thus, with the hotter and less viscous plastic ejected first, initiation of ejection is easier than in systems that eject the cooler plastic first. This is particularly advantageous where, as in the present invention, the bleeding of fluid plastic is delayed to allow for adequate surface during of the part, thus decreasing the fluidity of the plastic on the interior of the part, particularly at the points remote from the gate. Bleeding the most fluid plastic from the mold first is the most efficient way to remove the greatest amount of still cooling fluid plastic and facilitates plastic ejection without the need for excessively high fluid injection pressures. This also reduces the chance of more cooled/less fluid plastic impeding the flow of less cooled/more fluid plastic toward and through the gate. Since the pin(s) 24 is/are located at the remote end(s) of the cavity, there is also less chance of flashing or fluid plastic encroachment into the pin. Further still, when runner 14 is packed with the ejected plastic material, the cooler and more viscous portion of the melt will occupy the upstream side of gate 22. Thus, upon opening of the respective halves of mold body 20 to remove the molded part, the plastic immediately adjacent the mold cavity (at the injection end 15 of runner 14) is relatively cooler and firmer than the plastic at the opposite end 17 of runner 14. This partially cooled plastic separates more cleanly from the molded part than hotter, less viscous plastic would, resulting in a cosmetically superior molded part.

It should be appreciated that the fluid may be injected via pin 24 prior to opening of valve 25, then halted, allowing the built up pressure to drive plastic from the mold when valve 25 is opened. Alternatively, fluid may be injected before opening valve 25, as well as after the valve is opened. Related schemes could be undertaken wherein valve 25 is operated to allow an initial pressure buildup (held closed), followed by a pressure drop (opened), then followed by another build (closed). A preferred embodiment is to utilize a gas controller utilizing a pressure regulator such as a GO DL-57 regulator, which when combined with a servo controller such as a Proportionair BBZ, can maintain a pre-selected pressure as the plastic cools, and or injected fluid maintains the pressure as the reservoir is opened The various possible fluid injection schemes are available for different mold and plastic characteristics and considerable variation on the presently disclosed processes is possible without departing from the scope of the present invention. For instance, any of the fluid injection events could be undertaken with either a gas or a liquid, for instance water. The plastic injectors, mold cavities, runners and cylinders are all known in the art. Suitable injection pins such as Applicant's ANP series gas pin or multi fluid pin are commercially available, as are fluid injection controllers, such as Applicant's LGC series gas assist controller, which can adjust the pressure and timing of fluid introduced into the chambers.

Another alternative involves initially supplying fluid to cavity 20, halting the fluid supply while a quantity of plastic is ejected, then again supplying fluid after a main portion of plastic has been injected. This “counter pressure” particularly using a gas, may be particularly useful in controlling the injection of foam plastics or the injection of less viscous materials. As plastic is injected, the pressure of the gas may be maintain by bleeding gas back out of the gas injection nozzle. thus, similar to known methods of varying or maintaining a gas pressure profile within the cavity after plastic injection, the pressure within the cavity confronting the injection of plastic can be varied or maintained before and during the plastic injection. It is preferred that the gas pressure be decreased shortly after the initial plastic injection, which will compensate for the increasing viscosity of the fluent plastic as it cools, allowing for a more constant flow rate. This concept can be extrapolated to use within the overflow reservoir. Fluid and preferably gas injection pins can be located within the overflow reservoir to create an initial resistance to the flow of plastic, which resistance can be lower to promote the plastic overflow. If the passage between the overflow reservoir and the mold cavity is left open, the injection of gas through an overflow reservoir opposite the plastic injection inlet can be utilized to create the initial counter pressure within the mold cavity as shown in FIG. 3.

Variable volume overflow reservoirs can be used in conjunction with the process described above. Such devices provide a more accurate restriction on the amount of plastic permitted to flow out of the mold cavity and provide a more graduated control of the rate of overflow by increasing the volume of the reservoir during the plastic overflow. This timing and rate of volume adjustment can be preprogrammed can be readily adjusted to accommodate changes in ambient conditions. This approach is particularly useful with respect to the process described in FIG. 2.

As shown in FIG. 4, the embodiment of FIG. 2 can be altered to include a variable volume reservoir (components in FIG. 4 that are the same as FIG. 2 are numbered as in FIG. 2 with an addition of a “′”, thus the mold cavity of FIG. 4 is 20′). By retracting the piston 28′ the volume of the overspill reservoir 16′ is increased.

It should be understood that the present description is for illustrative purposes only and should not be construed to limit the scope of the present invention in any way. Thus, those skilled in the art will appreciate that various modifications could be made to the presently disclosed embodiments without departing from the intended spirit and scope of the present invention. Other aspects, features, and advantages will be apparent upon an examination of the attached drawing figures and appended claims.

What is claimed is:

1. An injection molding apparatus comprising:
a mold body having a cavity for forming a hollow molded plastic part;
a runner for supplying fluent plastic to said cavity;
a least one fluid injection pin mounted to said mold body and connectable to a fluid source;
a reservoir positioned remote from said cavity and selectively connectable to said runner; and
a valve positioned adjacent a mouth of said runner, said valve being operable between a first state at which said reservoir is fluidly connected to said runner, and a second state at which said reservoir is blocked from fluid communication with said runner.

2. The injection molding apparatus of claim 1 wherein said mold cavity has an upstream end and a downstream end;
said runner is fluidly connected to said mold cavity at a gate positioned adjacent said upstream end; and
said at least fluid injection pin is positioned proximate said downstream end.

3. The injection molding apparatus of claim 2 wherein said gate directs fluent plastic into said mold cavity in a substantially downstream direction during a plastic injection cycle, and said at least one fluid injection pin directs fluid into said mold cavity in substantially upstream direction during a plastic ejection cycle.

4. The injection molding apparatus of claim 1 further comprising actuating means for operating said valve member between said first and said second states.

5. The injection molding apparatus of claim 4 wherein said valve is hydraulically actuated.

6. The injection molding apparatus of claim 4 wherein said valve is pneumatically actuated.

7. The injection molding apparatus of claim 4 wherein said valve is electromechanically actuated.

8. The injection molding apparatus of claim 1 wherein a volume of said runner is greater than or equal to a volume of plastic ejected from said cavity by fluid injected through said at least one fluid injection pin.

9. The injection molding apparatus of claim 1 wherein said mold cavity has an upstream end and a downstream end;
said runner is fluidly connected to said mold cavity at a gate positioned adjacent said upstream end; and
said at least one fluid injection pin is positioned proximate said downstream end.

10. The injection molding apparatus of claim 4 wherein said valve is electromechanically actuated.

11. The injection molding apparatus of claim 1 wherein said reservoir has a selectively variable volume.

12. A process for injection molding of fluid filled plastic bodies in an apparatus having a mold cavity and a fluid reservoir, the process comprising the steps of:
injecting a quantity of flowable plastic into an interior of the mold cavity through a supply passage;
cooling part of the plastic melt along walls of the mold cavity, thereby providing an interior of flowable, plastic melt;
injecting fluid from the fluid source into the interior of flowable, plastic melt;
selectively expelling at least a portion of the interior of flowable, plastic melt into the supply passage; and
selectively expelling at least a portion of fluent plastic from the supply passage into the reservoir.

13. A process for injection molding of plastic bodies in a molding apparatus having a mold cavity, the process comprising the steps of:
injecting flowable plastic into the mold cavity;
injecting pressurized compressible fluid into the interior of said flowable plastic in said cavity, increasing the pressure within said cavity then to a predetermined pressure; then
selectively connecting the mold cavity with a reservoir after a portion of said flowable plastic flows from the mold cavity.

14. The process of claim 13 wherein said step of selectively connecting is characterized by actuating a control valve to fluidly connect the mold cavity with the reservoir.

15. The process of claim 13 wherein said portion of the interior of flowable plastic flows from the mold cavity in the direction of said injection of flowable plastic.

16. The process of claim 13 wherein said portion of the interior of flowable plastic flows from the mold cavity in an upstream direction opposite the direction of said injection of flowable plastic.

17. A process for injection molding of hollow articles in an apparatus having a mold cavity and a reservoir, the process comprising the steps of:
injecting fluent plastic into the apparatus;
injecting a pressurized compressible fluid into the fluent plastic, the fluid forming a pocket of pressurized fluid therein;
substantially maintaining fluid a predetermined pressure in the mold for a predetermined duration; and
selectively connecting the mold cavity to the reservoir, so that a portion of the fluent plastic flows to the reservoir.

18. The process of claim 17 wherein the predetermined duration is about two seconds to about ten seconds.

19. The process of claim 17 wherein the step of selectively connecting the mold cavity to the reservoir includes actuating a control valve to fluidly connect the mold cavity therewith.

20. The process of claim 17 wherein the portion of fluent plastic flows to the reservoir in a downstream direction.

21. The process of claim 17 wherein said portion of the fluent plastic flows from the mold cavity in the direction of said injection of fluent plastic.

22. The process of claim 17 wherein said portion of the fluent plastic flows from the mold cavity in a direction opposite to the direction of said injection of fluent plastic.

23. A method for injection molding a part having at least one cavity therein, comprising the steps of;
injecting thermoplastic melt into a cavity of an injection molding tool to partially fill the cavity;
injecting a core fluid into the thermoplastic melt; and
injecting a control fluid into a reservoir in fluid communication with said cavity.

24. The method of claim 23 wherein at least a portion of said thermoplastic melt is expelled from said cavity into said reservoir.

25. The method of claim 24 wherein said control fluid opposes the flow of said thermoplastic melt into said reservoir.

26. The method of claim 25 wherein the injection of said control fluid is selected to control the rate of flow of said thermoplastic melt.

27. The method of claim 23 wherein one of said fluids is water.

28. A method for injection molding a part having at least one cavity therein, comprising the steps of;
injecting thermoplastic melt into a cavity of an injection molding tool to partially fill the cavity;
injecting a core fluid into the thermoplastic melt; and
injecting a control fluid into said cavity downstream of said thermoplastic melt.

29. The method of claim 28 wherein at least a portion of said thermoplastic melt is expelled from said cavity into a reservoir.

30. The method of claim 28 wherein said control fluid opposes the flow of said thermoplastic melt into said reservoir.

31. The method of claim 28 wherein the injection of said control fluid is selected to control the rate of flow of said thermoplastic melt.

32. The method of claim 28 wherein one of said fluids is water.

33. An injection molding apparatus comprising:
a mold body having a cavity for forming a hollow molded plastic part;
an inlet for injection of fluent plastic into said cavity;
two fluid injection pins mounted to said mold body at spaced apart locations in said mold cavity along the flow path of said fluent plastic, each of said pins connected to a discrete fluid source.

34. An injection molding apparatus comprising:
a mold body having a cavity for forming a hollow molded plastic part;
an inlet for the injection of fluent plastic fluidly into said cavity;
a first fluid injection pin in direct fluid communication with said cavity;
a reservoir in fluid communication with said cavity; and
a second fluid injection pin in direct fluid communication with said reservoir.

35. The apparatus of claim 34 wherein said first fluid injection pin located at between said inlet and said reservoir.

36. The apparatus of claim 34 further comprising a runner for delivering said fluent plastic to said inlet, at least a portion of said runner defining a flow path between said reservoir and said cavity.

37. The apparatus of claim 34 further comprising at least two distinct fluid sources.

38. The apparatus of claim 34 wherein said fluid injection pins are connected to distinct fluid sources.

39. The apparatus of claim 34 further comprising a source of water.
